(19) United States
(12) Patent Application Publication
(10) Pub. No.: US 2007/0102364 A1
(43) Pub. Date: May 10, 2007

(54) Chelate adsorbents that can be used in a strongly acidic region

(75) Inventors: Kenji Okada, Takasaki-shi (JP); Noriaki Seko, Takasaki-shi (JP); Masao Tamada, Takasaki-shi (JP)

Correspondence Address: STAAS & HALSEY LLP, SUITE 700, 1201 NEW YORK AVENUE, N.W., WASHINGTON, DC, 20005, US

(73) Assignee: JAPAN ATOMIC ENERGY AGENCY, Ibaraki (JP)

(21) Appl. No.: 11/594,238

(22) Filed: Nov. 8, 2006

(30) Foreign Application Priority Data
Nov. 9, 2005 (JP) 324600/2005

(51) Int. Cl. B01J 39/00

(52) U.S. Cl. 210/660

(57) ABSTRACT

To produce a bifunctional adsorbent capable of adsorption in the acidic region, a polymeric substrate is first exposed to a radiation and then a phosphonic acid group suitable for metal adsorption and a sulfonic acid group are introduced into the substrate by graft polymerization.

### BACKGROUND OF THE INVENTION

This invention relates to adsorbents that are made of metal ion removing chelate adsorbent fibers and which may typically be used in the treatment of wastewater in the acidic region.

Ion adsorbents of a phosphoric and phosphonic acid type are good adsorbers of divalent ions such as Cu(II) and Pb(II) at near neutrality but their adsorption capacity and rate drop in the acidic region at pH 2 and below. They also have difficulty in adsorbing trivalent ions such as Fe(III) for two reasons, i.e., at near neutrality, ligand exchanging is slow and bulky binuclear hydroxide complex ions form. Information about these adsorption techniques is given in the following known prior art references:
1. Akinori JYO and others, “Phosphonic Acid Fiber for Selective and Extremely Rapid Elimination of Lead” in ANALYTICAL SCIENCE 2001, Vol. 17, SUPPLEMENT 2001, The Japan Society for Analytical Chemistry;
2. Shoji AOKI and others, “Phosphoric Acid Fiber for Extremely Rapid Elimination of Heavy Metal Ions from Water” in ANALYTICAL SCIENCE 2001, Vol. 17, SUPPLEMENT 2001, The Japan Society for Analytical Chemistry;
3. Akinori Jyo and Xiaoping Zhu, “METAL-ION SELECTIVITY OF PHOSPHORIC ACID RESIN IN AQUEOUS NITRIC ACID MEDIA” in Chemistry for the Protection of the Environment 3, edited by Pawlowsky et al., Plenum Press, New York, 1998.

### SUMMARY OF THE INVENTION

Conventional commercial adsorbent resins have the problem that adsorption capacity and rate drop during use in the acidic region. In addition, they have been unable to adsorb metal ions such as Fe(III) in the neutral region because not only are they slow in ligand exchanging but they also form bulky binuclear hydroxide complex ions that tend to precipitate.

An object, therefore, of the present invention is to provide an adsorbent that allows for adsorption in the acidic region.

Another object of the present invention is to provide an adsorbent that facilitates adsorption in the neutral region at faster rate and which have higher adsorption capacity.

### BRIEF DESCRIPTION OF THE DRAWINGS

FIG. 1 is a graph showing adsorption profiles for a bifunctional fiber, a monofunctional fiber and a commercial resin (CRP) at various pHs;

FIG. 2 is a graph showing equilibrium adsorption capacity profiles for a bifunctional fiber and a commercial resin (CRP) at various pHs;

FIG. 3 is a graph showing the flow rate dependency of a bifunctional fiber and a monofunctional fiber during adsorption of Pb(II) ions in the neutral region; and

FIG. 4 is a graph showing the flow rate dependency of a bifunctional fiber and a monofunctional fiber during adsorption of Fe(II) ions.

### DETAILED DESCRIPTION OF THE INVENTION

The present invention provides adsorbents that can adsorb and remove metal ions dissolved in acidic wastewater, particularly those metal ions of higher valency which have small solubility products with the hydroxide ion.

The chelate adsorbent fibers of the present invention can be produced by relying upon the graft polymerization technique for providing various shapes of material with the desired adsorbing capability. In the present invention, polypropylene, polyethylene or natural polymer fibers, polyester fibers or fibers of their composites are used as the substrate for preparing chelate adsorbent fibers of a phsophonic acid type, a sulfonic acid type, or a complex thereof. The chelate adsorbent fibers may assume various forms including short cut filaments, nonwoven fabrics, woven fabrics, and long filaments.

The chelate adsorbent fibers of the present invention are produced by a process comprising the steps of exposing a polymer substrate to an electron beam or other radiations and then performing a graft polymerization technique that enables a metal ion adsorbing capability to be incorporated in the presence of an added reactive monomer reagent.

In the present invention, polyethylene or otherwise made fibers are used as the polymer substrate, into which reactive monomers permitting the introduction of at least two functional groups such as a phosphonic acid group and a sulfonic acid group that contribute to the adsorption of metal ions are introduced by graft polymerization.

Thus, the present invention produces a bifunctional adsorbent by first exposing a polymer substrate to a radiation and then performing graft polymerization such that two reactive monomers, one having a phosphonic acid group and the other having a sulfonic acid group, are introduced into the substrate. Alternatively, the present invention produces a bifunctional adsorbent by first exposing a polymer substrate to a radiation, then performing graft polymerization such that two reactive monomers, one permitting the introduction of a phosphonic acid group and the other permitting the introduction of a sulfonic acid group, are introduced into the substrate and thereafter introducing phosphonic and sulfonic acid groups.

The chelate adsorbent fiber of the present invention was compared for performance (adsorption capacity) with a commercial chelate resin and a monofunctional fiber (an adsorbent fiber having a single type of functional group had been introduced) by measuring the concentration of Pb(II) ions in solution; the fiber of the present invention was more than twice in adsorption capacity at pH of 2 or less. The adsorbent fiber of the present invention was also compared with the monofunctional fiber for the flow rate dependency of Fe(III) adsorption; the fiber of the present invention showed a satisfactory adsorption behavior at more than 100 times faster flow rates.

The chelate adsorbent fiber as produced by radiation induced graft polymerization in accordance with the present invention exhibits better adsorption performance than the monofunctional fiber and the commercial chelate resin (DIAION CRP200 of Mitsubishi Chemical Co.) and hence is promising for use in the treatment of acidic wastewater.

Exposure to radiation is performed on a preliminarily nitrogen-purged polymer substrate as it is placed in a nitrogen atmosphere either at room temperature or under cooling with Dry Ice. The radiation to be used is either an electron beam or γ-rays and the dose of irradiation can appropriately be determined to satisfy the condition that it be sufficient to generate active points for the reaction; a typical value is between 5 and 200 kGy.

### EXAMPLES

The present invention is described below in greater detail with reference to examples.

### Example 1

### Synthesis of Adsorbent Using Nonwoven Fabric as Polymer Substrate into which Phosphonic Acid and Other Groups were Introduced by Irradiation

A nonwoven fabric as a polymer substrate was irradiated to generate reactive points for the reaction. To this end, an electron beam was applied in a nitrogen atmosphere to give a total dose of 200 kGy. Subsequently, two monomers having a vinyl group, i.e., chloromethylstyrene and styrene, were reacted at a weight ratio of 4:1 in DMSO (dimethyl sulfoxide) at 40° C. for 3-24 hours to give monomer concentrations of 10-50%, thereby introducing graft chains into the fiber yarns.

Conversions obtained by 2- and 3-hour reactions at 40° C. were 100% and 130%, respectively. After introducing triethyl phosphite/phosphonic acid complex groups, chlorosulfonic acid was used to sulfonate the substrate, thereby producing a grafted, bifunctional chelate adsorbent fiber having phosphonic and sulfonic acid groups introduced therein. When Pb(II) ions were fed into the fiber, the feed solution could be recovered up to a functionality concentration of 90% without any loss.

### Example 2

### Pb(II) Ion Adsorption Test with Chelate Adsorbent Fiber

The bifunctional chelate adsorbent fiber having phosphonic and sulfonic acid groups introduced therein was conditioned by alternating hydrochloric acid and sodium hydroxide and subjected to an adsorption test. A Pb(II) ion solution as the feed was adjusted to 0.001 M before the adsorbent fiber was immersed in it, which was then agitated at 20° C. for 24 hours at various pH values between 0 and 3.0.

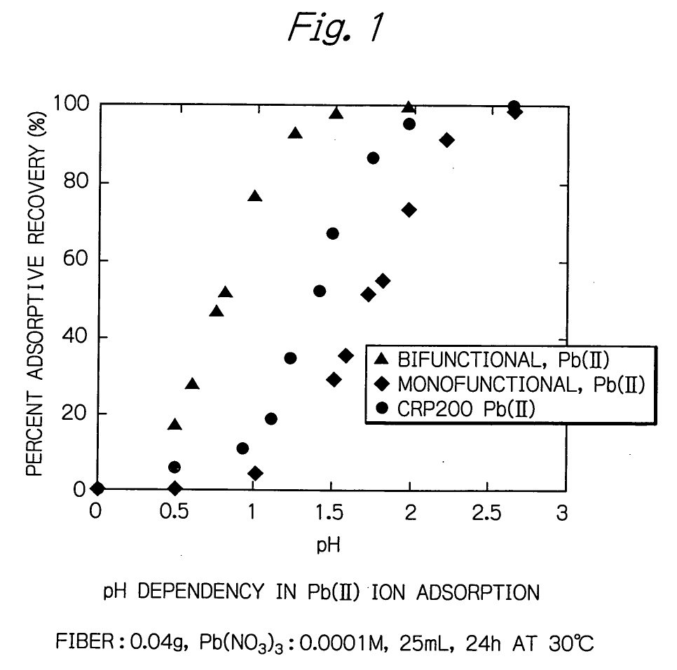

As FIG. 1 shows, the bifunctional fiber of the present invention exhibited adsorptive recoveries of at least 90% in the region below pH 1. In other words, the bifunctional fiber of the present invention enables efficient adsorption in a strongly acidic region below pH 1.

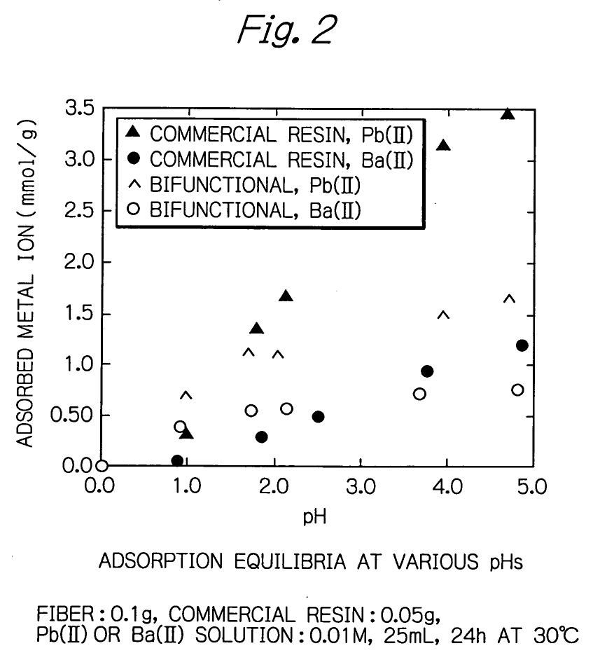

In addition, as FIG. 2 shows, compared to the commercial resin having three times as much capacity for functional groups, the fiber of the present invention exhibited twice as much adsorption capacity in the strongly acidic region of pH 1. In other words, the bifunctional fiber of the present invention which had a capacity for functional groups three times less than the commercial resin showed an adsorption capacity at least twice as much at pH of one or less.

### Example 3

### Test for the Flow Rate Dependency of Chelate Adsorbent Fiber in Pb(II) and Fe(II) Ion Adsorption

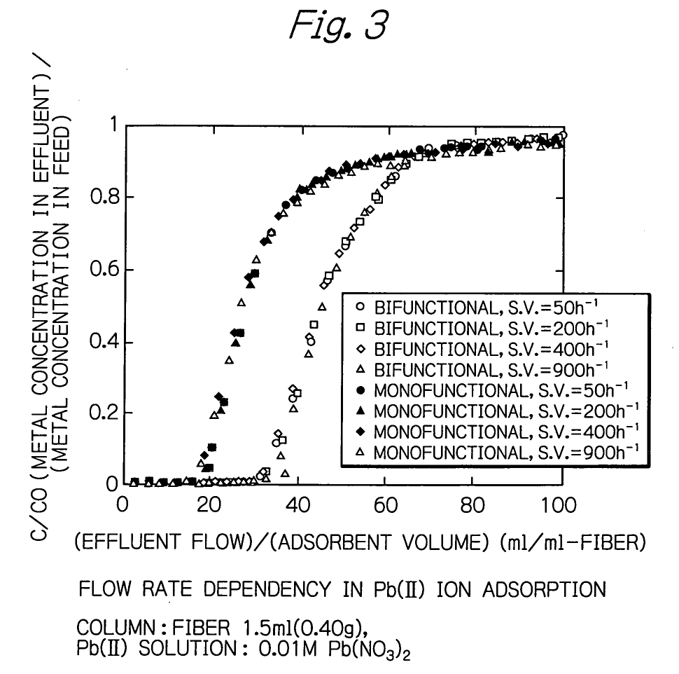

The bifunctional chelate adsorbent fiber into which phosphonic and sulfonic acid groups had been introduced was packed into a column having an inside diameter of 7 mm and then conditioned by alternating hydrochloric acid and sodium hydroxide before it was subjected to an adsorption test. Two feeds, one being a Pb(II) ion solution and the other being a Fe(III) ion solution, were each adjusted to 0.01 M, provided that the Fe(III) ion solution was also adjusted to pH 1.8; the feeds were then passed through the column at space velocities (S.V.) in the range of 40 to 1000 h⁻¹. As FIG. 3 shows, the bifunctional chelate adsorbent fiber of the present invention enabled rapid adsorption of Pb(II) ions even at the space velocity of 1000 h⁻¹. This is clear from the matching between the shapes of breakthrough curves at the space velocity of 900 h⁻¹.

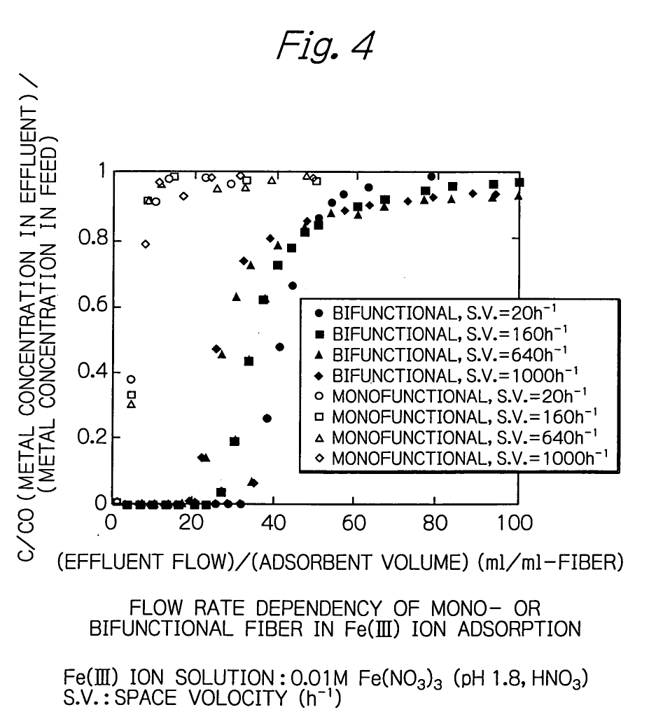

As FIG. 4 shows, only the bifunctional chelate adsorbent fiber of the present invention enabled rapid adsorption of Fe(III) ions. The performance of the bifunctional adsorbent fiber having phosphonic acid groups was particularly high in the strongly acidic region. To be more specific, as FIG. 4 shows, the feed solution started to leak just after it was passed through the monofunctional fiber; on the other hand, the bifunctional fiber showed efficient adsorption of Fe(III) ions began at space velocities of 20-1000 h⁻¹ in spite of the operation in a low pH region.

If the chelate adsorbent of the present invention is applied to acidic wastewater containing metal ions, the latter can be removed most satisfactorily in a strongly acidic range in terms of adsorption rate, adsorption capacity, and selectivity.

1. A chelate adsorbent that can be used in a strongly acidic region and which is produced by first exposing a polymer substrate to a radiation and then either grafting to the substrate those reactive monomers which have functional groups including a phosphonic acid group suitable for metal adsorption or grafting reactive polymers to the substrate, followed by introducing said functional groups into the resulting graft chains.

2. The adsorbent according to claim 1, wherein the polymer substrate is a polypropylene, polyethylene or polyester fiber, a fiber of a natural polymer such as cellulose, or a fiber of their composites.

3. The adsorbent according to claim 1 or 2, wherein the reactive monomer is a vinyl reactive monomer having a phosphonic acid group into which a chelate forming group can be introduced or a reactive monomer into which a functional group that permits the introduction of a phosphonic acid group can be introduced by graft polymerization.

4. The adsorbent according to claim 1 or 2, wherein the reactive monomer having a phosphonic acid group is a monomer that permits the introduction of a second functional group such as a sulfonic acid group.

5. The adsorbent according to claim 1 or 2, which is of at least two functionality comprising a phosphonic acid group and at least one other functional group useful in metal adsorption or which is a mixture of an adsorbent having phosphonic acid groups and a monofunctional adsorbent.

6. The adsorbent according to claim 5, which contains a phosphonic acid group and at least one other functional group that aids in swelling the adsorbent or which is a mixture of an adsorbent having phosphonic acid groups and a monofunctional adsorbent.

7. The adsorbent according to claim 6, wherein the functional group that aids in swelling the adsorbent is a sulfonic acid group, an ammonium group, a functional group working as a nitro group, a functional group working as a marked hydrophilic group, or a functional group which itself has an adsorbing capability.

8. The adsorbent according to claim 3, wherein the reactive monomer having a phosphonic acid group is a monomer that permits the introduction of a second functional group such as a sulfonic acid group.

9. The adsorbent according to claim 3, which is of at least two functionality comprising a phosphonic acid group and at least one other functional group useful in metal adsorption or which is a mixture of an adsorbent having phosphonic acid groups and a monofunctional adsorbent.

10. The adsorbent according to claim 4, which is of at least two functionality comprising a phosphonic acid group and at least one other functional group useful in metal adsorption or which is a mixture of an adsorbent having phosphonic acid groups and a monofunctional adsorbent.

11. The adsorbent according to claim 3, which contains a phosphonic acid group and at least one other functional group that aids in swelling the adsorbent or which is a mixture of an adsorbent having phosphonic acid groups and a monofunctional adsorbent.

12. The adsorbent according to claim 4, which contains a phosphonic acid group and at least one other functional group that aids in swelling the adsorbent or which is a mixture of an adsorbent having phosphonic acid groups and a monofunctional adsorbent.

13. The adsorbent according to claim 11, wherein the functional group that aids in swelling the adsorbent is a sulfonic acid group, an ammonium group, a functional group working as a nitro group, a functional group working as a marked hydrophilic group, or a functional group which itself has an adsorbing capability.

14. The adsorbent according to claim 12, wherein the functional group that aids in swelling the adsorbent is a sulfonic acid group, an ammonium group, a functional group working as a nitro group, a functional group working as a marked hydrophilic group, or a functional group which itself has an adsorbing capability.
